(19) United States
(12) Patent Application Publication
(10) Pub. No.: US 2025/0299382 A1
(43) Pub. Date: Sep. 25, 2025

(54) AUTOMATICALLY GENERATING AVATARS FROM USER IMAGES

(71) Applicant: GLANCEINMOBI PTE.LIMITED, Singapore (SG)

(72) Inventors: Anand Wadodkar, Karnataka (IN); Rohan Choudhary, Karnataka (IN); Rumit Singh Anand, Karnataka (IN); Pradeep Kumar Pajjiwar, Karnataka (IN); Srishti Bhaduri, Karnataka (IN)

(73) Assignee: GLANCEINMOBI PTE.LIMITED, Singapore (SG)

(21) Appl. No.: 19/087,019

(22) Filed: Mar. 21, 2025

(30) Foreign Application Priority Data
Mar. 21, 2024 (IN) 202411021666

(51) Int. Cl. G06T 11/00; G06V 40/16

(52) U.S. Cl. CPC G06T 11/00; G06V 40/171

(57) ABSTRACT

A method and a system for automatically generating avatars from user images. The method comprises receiving, by a processing unit, one or more images. Next, at least one user profile is generated based on the one or more images by the processing unit. Furthermore, the method comprises processing the at least one user profile with one or more template profiles by the processing unit. The method further comprises generating one or more avatars for one or more collections by the processing unit based on the processed at least one user profile. The method further comprises displaying, by the processing unit, the one or more avatars from the one or more collections on a computing device.

### TECHNICAL FIELD

The present disclosure generally relates to methods and systems of information technology and image generation techniques. More particularly, the present disclosure relates to a method and system for automatically generating avatars from user images.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as an admission of prior art.

Users have always been interested in putting pictures selected by them on their devices such as smartphones, tablets, computers, etc. Traditionally, the users have limited options for this. For example, they can select images from a library in their devices, or they can choose a web application that can provide random images to be shown on their devices. However, the images that are shown to the users on their devices are either random as provided by a third party or clicked by users themselves. The lock screen of a digital device despite being a constantly visible feature has been a static feature traditionally, with limited ability to enhance user experience on the surface. There has been an increased interest in seeking ways to reflect a user's personalities and preferences through their devices. However, existing solutions for lock screen customization have been inadequate in addressing this user need. At best, the users can select a list of images in a folder in their device, and the device randomly picks the images from the folder to be shown to the user as a wallpaper on the home screen, lockscreen, or any other window on the user device selected by the user. However, with the advent of technologies, it is now possible to generate dynamic and personalised artistic content based on various techniques. One of those techniques involve using artificial intelligence (AI) systems that may resonate with the preferences of the user. Still, this potential is mostly unrealized when considering commonplace technology interfaces such as lock screens.

Thus, there is a gap in creation with the user interface of user devices, and more so for lock screen environment related to the user interface of the user devices. There is a need in the existing art to develop systems and methods to create, curate and display wallpapers that resonate with the user's individual taste and context. Such approaches might contribute to transform the user interface of user devices such as a lock screen from a mere gateway to the device's functionality and enriching the user experience through personalized, context-aware art displays.

### SUMMARY

This section is provided to introduce certain aspects of the present disclosure in a simplified form that are further described below in the detailed description. This summary is not intended to identify the key features or the scope of the claimed subject matter.

An aspect of the present disclosure may relate to a method for automatically generating one or more avatars from at least one user image. The method comprises receiving, by a processing unit, one or more images. Further, the method comprises generating, by the processing unit, at least one user profile based on the one or more images. Furthermore, the method comprises merging, by the processing unit, the at least one user profile with one or more template profiles of one or more collections. Hereinafter, the method comprises generating, by the processing unit, one or more avatars for the one or more collections. Further, the method comprises displaying, by the processing unit, the one or more avatars from the one or more collections on a computing device.

In an exemplary aspect of the present disclosure, the method further comprises personalizing, by the processing unit, the one or more avatars from the one or more collections based on face swap using the at least one user profile.

In an exemplary aspect of the present disclosure, the method further comprises identifying, by the processing unit, at least one user face and one or more facial features associated with the at least one user face in the one or more images, wherein the at least one user profile comprises one or more facial features associated with the at least one user face.

In an exemplary aspect of the present disclosure, the one or more avatars are generated based on a location, a time, a weather, a user preference and a user behavior.

In an exemplary aspect of the present disclosure, the one or more collections are based on one or more themes and wherein the one or more avatars in the one or more collections is generated based one or more parameters associated with one or more themes.

Another aspect of the present disclosure may relate to a system automatically generating one or more avatars from at least one user image. The system comprises a processing unit connected to a storage unit, said processing unit configured to receive one or more images. The processing unit is further configured to generate at least one user profile based on the one or more images. Furthermore, the processing unit is configured to merge the at least one user profile with one or more template profiles of one or more collections. The processing unit is further configured to generate one or more avatars for the one or more collections. The processing unit is furthermore configured to display the one or more avatars from the one or more collections on a computing device.

Yet another aspect of the present disclosure may relate to a non-transitory computer readable storage medium storing instructions for automatically generating one or more avatars from at least one user image, the instructions include executable code which, when executed by one or more units of a system, cause a processing unit of the system to receive one or more images. The instructions when executed by the system further cause the processing unit to generate at least one user profile based on the one or more images. The instructions when executed by the system further cause the processing unit to merge the at least one user profile with one or more template profiles of one or more collections. The instructions when executed by the system further cause the processing unit to generate one or more avatars for the one or more collections. The instructions when executed by the system further cause the processing unit to display the one or more avatars from the one or more collections on a computing device.

### BRIEF DESCRIPTION OF DRAWINGS

The accompanying drawings, which are incorporated herein, constitute a part of this disclosure. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components. Although exemplary connections between sub-components have been shown in the accompanying drawings, it will be appreciated by those skilled in the art that other connections may also be possible, without departing from the scope of the invention. All sub-components within a component may be connected to each other, unless otherwise indicated.

FIG. 1 illustrates an exemplary system [100] for automatically generating avatars from user images on a computing device.

FIG. 2 illustrates an exemplary method [200] for automatically generating avatars from user images on a computing device.

FIG. 3 illustrates an exemplary method [300] for interaction of computing device with the server, in accordance with exemplary implementations of the present disclosure.

FIG. 4 illustrates an exemplary embodiment for automatically providing avatars generated from user images.

FIG. 5A illustrates an exemplary method [500A] for displaying an automatically generated avatar based on location of a computing device.

FIG. 5B illustrates an exemplary method [500B] for displaying an automatically generated avatar based on time of the day.

FIG. 5C illustrates a series of avatars [500C] created using a user provided image and a style reference image.

### DETAILED DESCRIPTION

In the following description, for the purposes of explanation, various specific details are set forth in order to provide a thorough understanding of the embodiments of the present invention. It will be apparent, however, that embodiments of the present invention may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present invention are described below, as illustrated in various drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes”, “has”, “contains”, and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a (Digital Signal Processing) DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a computing device”, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from at least one of a transceiver unit, a processing unit, a storage unit, a detection unit and any other such unit(s) which are required to implement the features of the present disclosure.

As used herein, “storage unit”, “database”, or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As used herein “interface” or “user interface” refers to a shared boundary across which two or more separate components of a system exchange information or data. The interface may also be referred to a set of rules or protocols that define communication or interaction of one or more modules or one or more units with each other, which also includes the methods, functions, or procedures that may be called.

As used herein, the term “collections” refers to an assortment of images or wallpapers, each designed to enhance the user's experience related to display on the user interface of the user device, such as the lock screen experience with specific aesthetic, functional, or interactive elements. Each collection may be unified by a central theme or concept. The wallpapers within a collection may vary in style, interactivity, and content, but all or a subset of the same may adhere to the common theme.

All modules, units, components used herein, unless explicitly excluded herein, may be software modules or hardware processors, the processors being a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASIC), Field Programmable Gate Array circuits (FPGA), any other type of integrated circuits, etc.

As discussed in the background section, owing to the gaps in the current known solutions there exists a need to develop systems and methods to create, curate and display wallpapers that resonate with the user's individual taste and context. Such approaches might contribute to transform the user interface of user devices such as a lock screen from a mere gateway to the device's functionality and enriching the user experience through personalized, context-aware art displays. The present invention relates to a novel method and system for automatically generating one or more avatars from at least one user image to display on a computing device, for instance using artificial intelligence (AI)-based systems. More particularly, the methods and systems of the present invention are an innovative and novel solution aimed for automatically displaying the one or more avatars to the user, the inventive process revolves around curating and personalizing the available display area on the lock screen of the computing device. At least some embodiments of this innovation goes beyond the conventional methods by using artificial intelligence to curate and create a dynamic and personalized lock screen display wallpaper. Furthermore, the solution encompasses scenarios where data can be acquired from the server without direct user intervention. In a practical implementation of this solution, the display on the lock screen can dynamically update in real time, influenced by factors chosen by the user such as change the lock screen based on location of the computing device, time of the day at the location of the computing device, and the like. This multi-faceted approach signifies a significant leap forward in enhancing personalized presentation and user engagement.

In order to overcome at least a few problems associated with the known solutions, in at least one embodiment a system and method provide a solution that can provide personalised and dynamic wallpapers for a computing device and provide a solution that can provide personalised collections for the users to choose one or more options to be displayed on the screen of the user device. In at least one embodiment, the system and method, provide a solution that can use a user context and other parameters to suggest the user a relevant set of collections and options to choose and display on the screen of the user device.

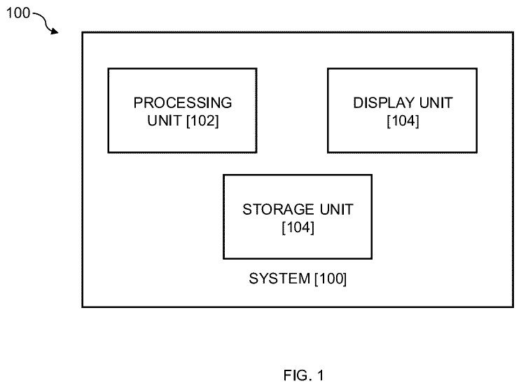

Referring to FIG. 1, an exemplary system [100] for automatically generating avatars from user images on a computing device is shown. The one or more avatars are generated based on a location, a time, a weather, a user preference and a user behavior, or the like. In an implementation, the system [100] may be present in a server device to implement the features of the present disclosure. The system [100] comprises at least one processing unit [102], at least one display unit [106] and at least one storage unit [104]. Also, all of the components/units of the system [100] are assumed to be connected to each other unless otherwise indicated below. As shown in the figures all units shown within the system should also be assumed to be connected to each other. In an implementation, the system [100] may comprise a communication unit [108] connected at least to the processing unit [102]. In an implementation, the system [100] comprises a separate AI unit [110] connected at least to the processing unit [102].

Also, in FIG. 1 only a few units are shown, however, the system [100] may comprise multiple such units or the system [100] may comprise any such numbers of said units, as required to implement the features of the present disclosure. Further, in an implementation, the system [100] may be present in a computing device to implement the features of the present disclosure. The system [100] may be a part of the computing device/or may be independent of but in communication with the computing device. Also, it is pertinent to note that the system [100] is exemplary, and the system [100] may work in conjunction with, one or more modules/units as required and/or as obvious to a person skilled in the art, to implement the features of the present disclosure.

The processing unit [102] is configured to receive one or more images. The one or more images may be uploaded by the user or collected by the processing unit [102] from the web. In an embodiment, the processing unit [102] may collect the one or more images from the web based on user preference, user history, and the like. For example, a user has an interest in nature, then the one or more images related to nature like trees, river, mountains, and the like may be collected by the processing unit [102]. Further in an implementation the one or more images may further comprise user's face.

The processing unit [102] is further configured to generate at least one user profile based on the one or more images. In an implementation of the present disclosure, the processing unit [102] may further comprise an artificial intelligence unit [102] to generate the at least one user profile. The at least one user profile refers to a file of basic understanding of features of the user. The processing unit [102] is further configured to identify at least one user face and one or more facial features associated with the at least one user face in the one or more images. In an implementation, the at least one user profile is trained based on known techniques such as DreamBooth. The DreamBooth creates the file based on understanding of the basic features of the user's appearance. The user's appearance includes the face, body, hair, etc., but the major focus may be on facial features.

Furthermore, the processing unit [102] is configured to merge the at least one user profile with one or more template profiles of one or more collections. The template profiles refers to a pre-existing model, like a standard checkpoint model. As used herein, the term “collections” refers to an assortment of images or wallpapers, each designed to enhance the user's experience related to display on the user interface of the user device, such as the lock screen experience with specific aesthetic, functional, or interactive elements. Each collection may be unified by a central theme or concept. The wallpapers within a collection may vary in style, interactivity, and content, but all or a subset of the same may adhere to the common theme.

In an implementation of the present disclosure, the at least one user profile may be merged with the one or more template profiles in the AI unit. In an exemplary implementation, the one or more template profiles may be a deliberate model and a dreamshaper model as already known in the art. In another embodiment of the present disclosure, the one or more template profiles may be any other model. The one or more template profiles may add unique style attributes to the at least one user profile. Further, the one or more templates may enhance the capability to generate the one or more avatars in varied styles. Furthermore, in an embodiment, the one or more template profiles may be used in a predetermined weight ratio. The predetermined weight ratio may be set by a system operator. The predetermined weight ratio may be used to generate the one or more avatars in realistic form. In an implementation of the present disclosure, the predetermined weight proportions may be:

$$Dreambooth Output Model - 0.7 - 0.8$$

$$Deliberate / dreamshaper Model - 2. - 0.3$$

The processing unit [102] is further configured to generate one or more avatars for the one or more collections. Each collection may comprise one or more images or intermediate avatars. Also, in an implementation, the one or more images in a collection may relate to a central theme or a common theme. The one or more avatars in a respective collection may also be generated based on one or more parameters associated with the respective theme. In one implementation of the present disclosure, the one or more parameters may be one of a location, a time, a weather, a user preference, a user behavior, and the like. For instance, for the collection based on the time of the day, the one or more avatars may include an avatar of the user in a morning sun background, a very bright avatar of the user in the afternoon sun background, a dull avatar of the user in a dark background for night, and the like.

In an embodiment of the present disclosure, post the generation of the one or more avatars, the one or more avatars may also be personalised. The process of personalisation ensures a balance between the set of images uploaded by the user and the one or more avatars created. The process of personalisation creates the one or more avatars with high resemblance to real images and high precision in replicating human-like features. In an implementation, the personalisation may be performed using Stable Diffusion 1.5 as known in the art. In another implementation, the personalisation may be performed using any other system.

The processing unit [102] is further configured to personalize (enhance) the one or more avatars from the one or more collections based on based on face swapping using the at least one user profile. In an implementation of the present disclosure, a face swap operation may be used to enhance the one or more avatars. The face swap operation may integrate the user's facial features into the one or more avatars. The face swapping technique ensures a high resemblance to the user, thereby personalizing each of the one or more avatars without detracting from the chosen theme. In an exemplary implementation, an upscaling technique may be applied to improve the quality of the swapped facial area to ensure clarity and detail. In an implementation of the present disclosure, the processing unit [102] may be configured to produce final images or the avatars after applying face swap algorithms and other image correction algorithms. Further, the processing unit [102] may store the one or more avatars in the storage unit [104]. The processing unit [102] is further configured to display the one or more avatars from the one or more collections on the display unit [106] of a computing device.

In an implementation of the present disclosure, the one or more collections may be updated without updating an application for collections in the user's computing device. For instance, a new collection theme is added to the server. The new collection theme is processed. The processing may be done to ensure compatibility with one or more computing devices and adherence to the standards of the application of collections. Once the processing is performed, the new collection theme may be sent to the user's computing device. The new collection theme may be sent using a system to dynamically update the new collection theme to the application for collections at the computing device without having the need to manually update the application.

In an exemplary implementation, when a new theme for collection is added, it is processed to ensure compatibility with various devices and adherence to the application's standards. Once ready, an information of the new theme collection is pushed to the user's device. This also eliminates the need for manual app updates. In operation, as the new theme collection becomes available, it is displayed on the user's lock screen for example, which alerts the users for exploring the new theme collection. Interaction is prompted as the user uploads personal images or grants permissions or perform the actions that trigger the personalization of the theme collection. Further, the processing unit [102] bundles the user data, customizing the new theme collection images to create a new avatars for the user. Thus, the final step of the process comprises updating the collection customised for the user, which is seamlessly integrated into the user device. The user can then apply the collection on the display of the user device, such as on the lock screen.

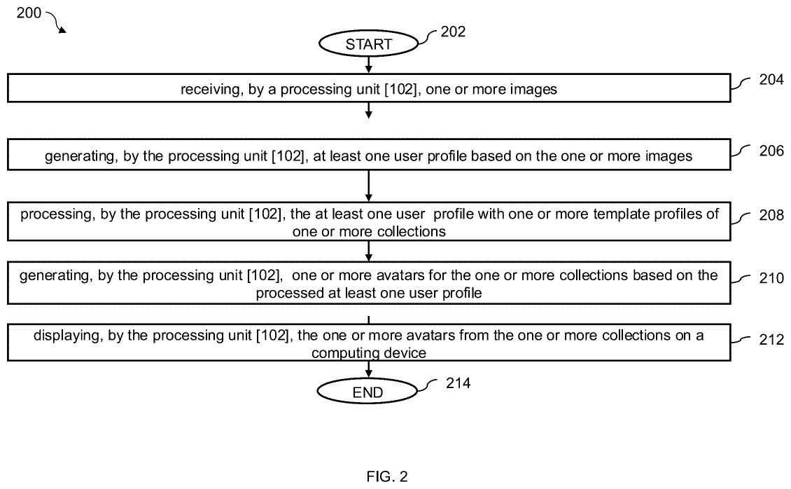

Referring to FIG. 2, an exemplary method flow diagram [200] automatically generating avatar based on user image on a computing device, in accordance with exemplary implementations of the present disclosure is shown. The one or more avatars are generated based on a location, a time, a weather, a user preference and a user behavior, or the like. In an implementation the method [200] is performed by a system [100]. Further, in an implementation, the system [100] may be present in a server device to implement the features of the present disclosure. The method starts at step [202] automatically at a pre-defined trigger as may be defined by the user of the system [100], such as at a pre-defined interval of time, and/or on addition of a new set of images by the user, and/or on receiving a user request for generating the avatars, etc. Also, as shown in FIG. 2, the method [200] starts at step [202].

At step [204], the method comprises receiving one or more images by a processing unit [102]. The one or more images may be uploaded by the user or collected by the processing unit [102] from the web. In an embodiment, the processing unit [102] may collect the one or more images from the web based on user preference, user history, and the like. For example, a user has an interest in nature, then the one or more images related to nature like trees, river, mountains, and the like may be collected by the processing unit [102]. Further in an implementation the one or more images may further comprise user's face.

Further, at step [206], the method comprises generating, by the processing unit [102], at least one user profile based on the one or more images. In an implementation of the present disclosure, the processing unit [102] may further comprise an artificial intelligence unit [102] to generate the at least one user profile. The method further comprises identifying, by the processing unit [102], at least one user face and one or more facial features associated with the at least one user face in the one or more images. The at least one user profile refers to a file of basic understanding of features of the user. In an implementation, the at least one user profile is trained based on known techniques such as DreamBooth. The DreamBooth creates the file based on understanding of the basic features of the user's appearance. The user's appearance includes the face, body, hair, etc., but the major focus may be on facial features.

At step [208], the method comprises merging the at least one user profile, by the processing unit [102], with one or more template profiles of one or more collections. The template profiles refers to a pre-existing model already known in the art. As used herein, the term “collections” refers to an assortment of images or wallpapers, each designed to enhance the user's experience related to display on the user interface of the user device, such as the lock screen experience with specific aesthetic, functional, or interactive elements. Each collection may be unified by a central theme or concept. The wallpapers within a collection may vary in style, interactivity, and content, but all or a subset of the same may adhere to the common theme.

In an implementation of the present disclosure, the at least one user profile may be merged with the one or more template profiles in the AI unit. In an exemplary implementation, the one or more template profiles may be a deliberate model and a dreamshaper model as already known in the art. In another embodiment of the present disclosure, the one or more template profiles may be any other model. The one or more template profiles may add unique style attributes to the at least one user profile. Further, the one or more templates may enhance the capability to generate the one or more avatars in varied styles. Furthermore, in an embodiment, the one or more template profiles may be used in a predetermined weight ratio. The predetermined weight ratio may be set by a system operator. The predetermined weight ratio may be used to generate the one or more avatars in realistic form. In an implementation of the present disclosure, the predetermined weight proportions may be:

$$Dreambooth Output Model - 0.7 - 0.8$$

$$Deliberate / dreamshaper Model - 2. - 0.3$$

Next, at step [210], the method comprises generating one or more avatars for the one or more collections by the processing unit [102]. Each collection may comprise one or more images or intermediate avatars. Also, in an implementation, the one or more images in a collection may relate to a central theme or a common theme. The one or more avatars in a respective collection may also be generated based on one or more parameters associated with the respective theme. In one implementation of the present disclosure, the one or more parameters may be one of a location, a time, a weather, a user preference, a user behavior, and the like. For instance, for the collection based on the time of the day, the one or more avatars may include an avatar of the user in a morning sun background, a very bright avatar of the user in the afternoon sun background, a dull avatar of the user in a dark background for night, and the like. At step [212], the method comprises displaying, by the processing unit [102], the one or more avatars from the one or more collections on the computing device.

In an embodiment of the present disclosure, post the generation of the one or more avatars, the one or more avatars may also be personalised. The process of personalisation ensures a balance between the set of images uploaded by the user and the one or more avatars created. The process of personalisation creates the one or more avatars with high resemblance to real images and high precision in replicating human-like features. In an implementation, the personalisation may be performed using Stable Diffusion 1.5 as known in the art. In another implementation, the personalisation may be performed using any other system.

The method further comprises personalizing, by the processing unit [102], the one or more avatars from the one or more collections based on face swap using the at least one user profile. In an implementation of the present disclosure, a face swap operation may be used to enhance the one or more avatars. The face swap operation may integrate the user's facial features into the one or more avatars. The face swapping technique ensures a high resemblance to the user, thereby personalizing each of the one or more avatars without detracting from the chosen theme. In an exemplary implementation, an upscaling technique may be applied to improve the quality of the swapped facial area to ensure clarity and detail. In an implementation of the present disclosure, the processing unit [102] may be configured to produce final images or the avatars after applying face swap algorithms and other image correction algorithms. Further, the processing unit [102] may store the one or more avatars in the storage unit [104].

In an implementation of the present disclosure, the method further comprises that the one or more collections may be updated without updating an application for collections in the user's computing device. For instance, a new collection theme is added to the server. The new collection theme is processed. The processing may be done to ensure compatibility with one or more computing devices and adherence to the standards of the application of collections. Once the processing is performed, the new collection theme may be sent to the user's computing device. The new collection theme may be sent using a system to dynamically update the new collection theme to the application for collections at the computing device without having the need to manually update the application.

In an exemplary implementation, the method further comprises that when a new theme for collection is added, it is processed to ensure compatibility with various devices and adherence to the application's standards. Once ready, an information of the new theme collection is pushed to the user's device. This also eliminates the need for manual app updates. In operation, as the new theme collection becomes available, it is displayed on the user's lock screen for example, which alerts the users for exploring the new theme collection. Interaction is prompted as the user uploads personal images or grants permissions or perform the actions that trigger the personalization of the theme collection. Further, the processing unit [102] bundles the user data, customizing the new theme collection images to create a new avatars for the user. Thus, the final step of the process comprises updating the collection customised for the user, which is seamlessly integrated into the user device. The user can then apply the collection on the display of the user device, such as on the lock screen.

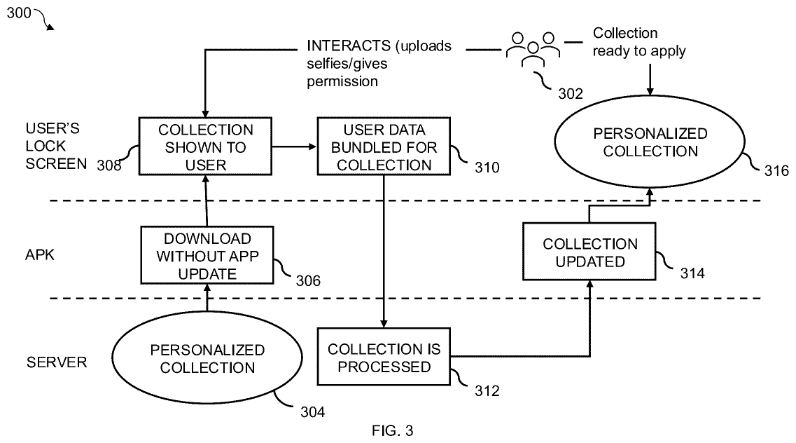

Referring to FIG. 3, it illustrates an exemplary method [300] for interaction of computing device with the server, in accordance with exemplary implementations of the present disclosure.

At step [302], the user interacts with the computing device to send the one or more images to the computing device. The one or more images includes but may not be limited to uploading selfies, or photos from the web, and the like. In one example, the one or more images from the web may be collected by the processing unit [102], based on user preference, user history, and the like. For example, a user has an interest in astronomy, then the one or more images related to astronomy may be collected by the processing unit [102]. The one or more images are used to train the user profile, where the user profile is created based on the one or more images. The user profile may be trained based on known techniques such as DreamBooth. The dreambooth results in creation of a file to understand basic features of the user's appearance with a major focus on the facial features.

Further, at step [304], a new collection with a new theme has been added to the server. The new collection is processed at the server to ensure compatibility with one or more computing devices and adherence to the standards of the application of collections. At step [306], the new collection is downloaded without updating the application of the user automatically without manual intervention. At step [308], after updating the application, the new collection along with the one or more collections may be shown to the user via a display unit at the computing device. The user may select one of the one or more collections according to their preference. For example, the user selects the personalised collection for dynamic wallpaper change based on location. At step [310], the one or more images uploaded by the user is merged with the collection selected by the user. In an implementation of the present disclosure, the merging may be performed using an Artificial Intelligence (AI) model.

At step [312], the one or more avatars generated for a specific collection is further processed. The processing may be done using a deliberate model and a dreamshaper model as already known in the art. The deliberate model and the dreamshaper model add unique style attributes to the at least one user profile. The unique weight ratio of stylisation using the deliberate model or the dreamshaper model along with the dreambooth model results in a more realistic and stylised avatar creation. In an embodiment, the weight ratio of the dreambooth model is 0.7-0.8 and the deliberate or the dreamshaper model is 0.2-0.3. The one or more avatars may be further personalised to maintain a balance between realistic and stylized representations. The personalisation may be AI based. The AI based personalisation creates avatars having high similarity to reality and leads to high precision in replication of human features to the avatars. Further, the one or more personalised avatars goes through an artistic styling process. In an example, the artistic styling may be performed using the Stable Diffusion 1.5 as already known in the art.

At step [314], the one or more personalised avatars are updated in the collection and is ready to be displayed at the computing device in a dynamic way. At step [316], the personalised collection may be displayed on the lock screen of the computing device at regular intervals of time.

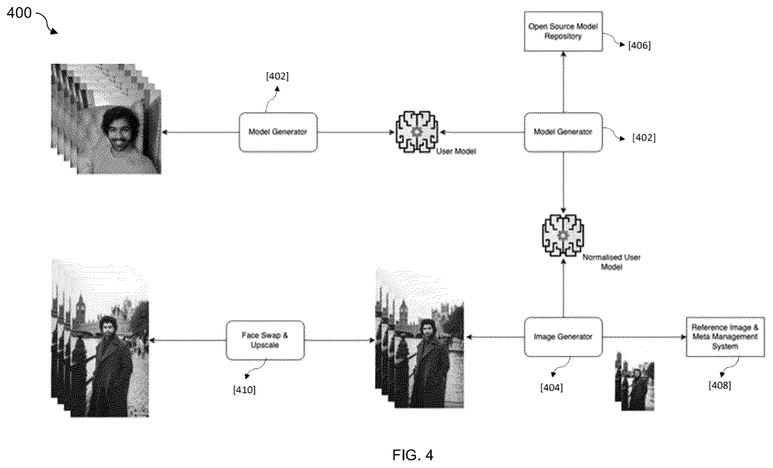

Referring to FIG. 4, it illustrates an exemplary embodiment [400] for automatically providing avatars generated from user images, in accordance with exemplary implementations of the present disclosure. The exemplary embodiment [400] comprises a model generator unit [402], an open source model repository unit [406], an image generator unit [404], a reference image and meta management system [408] and a face swap and upscale unit [410].

As per the implementation the processing unit [102] comprises the model generator unit [402]. The model generator unit [402] is configured to generate the at least one user profile based on the one or more images. The model generator unit [402] is further connected to the open source model repository unit [406]. The open source model repository unit [406] comprises one or more template profiles. The one or more template profiles includes any of the already known in the art template profiles. In one example, the one or more template profiles may be one of a dreamshaper model and a deliberate model. The one or more template profiles may be merged with the user profile to generate a merged model.

Further, the processing unit [102] may also comprise the image generator unit [404] which may be connected to the reference image & meta management system [408]. The image generator unit [408] receives a reference image from the reference image & meta management system [408]. The reference image & meta management system [408] may comprise one or more themes, such as location, time, and the like, a series of avatars featuring a person at an iconic landmark of a location where the person is at the current time. The reference image is seamlessly integrated with the user profile or the merged model using the image generator unit [404]. Thereafter, the image generator unit [404] generates a collection of the one or more images which are received by the processing unit [102]. In another embodiment, the image generator unit [404] generates a collection of the one or more avatars generated by the processing unit [102].

Further, in the implementation, the processing unit [102] comprises a face swap & upscale unit [410]. The face swap & upscale unit [410] may be configured to perform face swap algorithm and upscale technique to enhance the image by integrating the user facial expression into the avatars for high resemblance of the avatar with the user. Further, in the implementation, the face swap & upscale unit [410] may be applied to improve the quality of the swapped facial area, ensuring the clarity and detail and the set of collection of the one or more avatars produced.

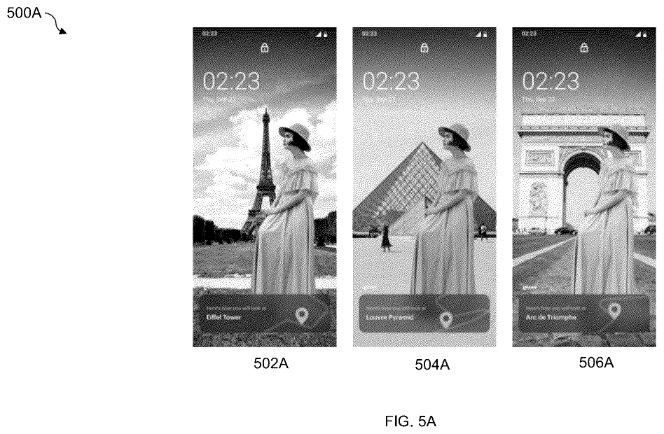

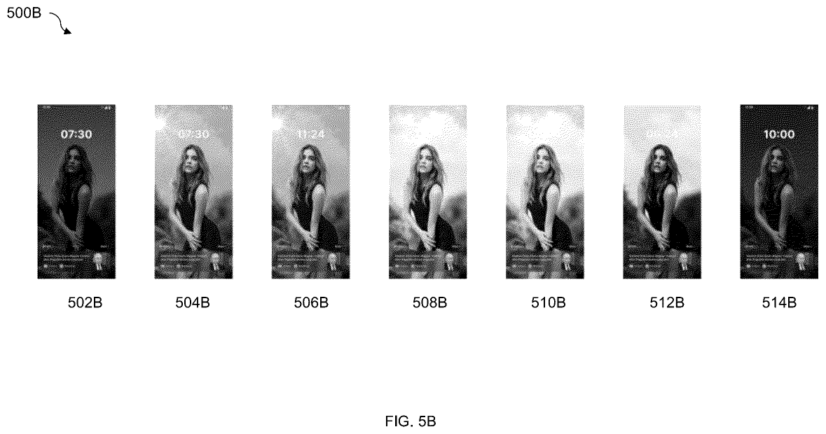

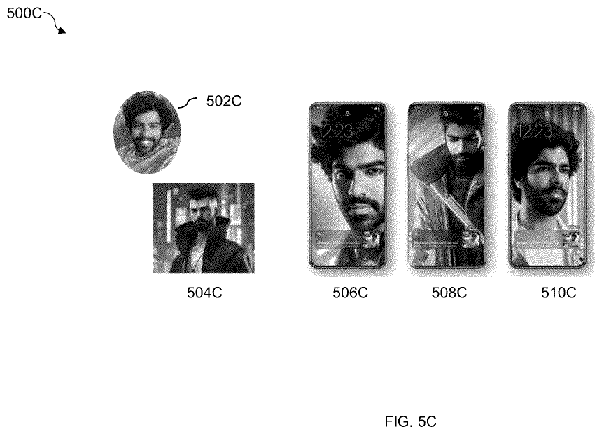

Referring to FIG. 5A, it illustrates an exemplary method [500A] for displaying an automatically generated avatar based on location of a computing device, in accordance with exemplary implementations of the present disclosure.

From the various themes of collections available on the application, in the exemplary embodiment, the user chooses for generation of avatars based on location of the computing device. The user may upload selfies, other favourite photos of the user on the computing device. The computing device's location may be detected at predefined intervals of time. The location may be detected using advanced global positioning system (GPS) and geofencing technologies. For instance, the location of the computing device is found to be Paris.

Based on the location, the system [100] as shown in FIG. 1, is configured to access a database to identify landmark or well-known monuments or historical places located in that city. The database contains one or more high quality images of the landmarks and one or more information of each of the one or more locations. For instance, the system [100] identifies Eiffel Tower stored as main landmark for city Paris. The high-quality image of Eiffel Tower is also stored in the database.

Further, the system [100] extracts the landmark image and integrates the landmark image with the one or more images uploaded by the user. In another embodiment where the user has not uploaded one or more images, the system [100] may extract images from the web based on Artificial Intelligence (AI) recommendations. The AI recommendations may be made based on recent images from user history and user preferences. The image extracted from the web may be seamlessly integrated with the images of the city's landmarks. The integration may be done using known in the art image blending techniques to ensure a natural and real image generation.

Further, the integrated image may be customized and resized to fit on the lock screen of the computing device. The step of customization includes optimizing the image to the standards of each computing device to ensure compatibility. In one embodiment, the integrated image for the location of Paris may look as at step [502A].

Further, after a predefined time period, based on the number of landmarks stored in the database for a specific city, the integrated image may be changed dynamically by the system [100]. For instance, at step [504A], the image of the user is integrated with Louvre Pyramid, another popular tourist destination in Paris. Step [506A] shows another landmark destination located in Paris integrated with the image of the user. The realistic images enhance user experience and increase user engagement.

As the user may travel within a city or a country, the wallpaper may be dynamically updated to feature different landmarks of the same city or different city based on the location. The dynamic update is based on the location of the user and can be set to change at specific intervals or in real-time.

Referring to FIG. 5B, it illustrates an exemplary method [500B] for displaying an automatically generated avatar based on time of the day, in accordance with exemplary implementations of the present disclosure. The user chooses for generation of avatars based on time of the day. The user may upload selfies, other favourite photos of the user on the computing device. The system [100] as shown in FIG. 1, may detect the time of the day at the computing device's location at predefined intervals of time. For instance, the location of the computing device is found to be Paris.

Based on the time of the day, the system [100], is configured to generate a background according to the time and integrate the background with the one or more images uploaded by the user. In another implementation, the background may be integrated with one or more images extracted from the web based on the user history and user preferences, where the one or more images are not uploaded by the user. The integration may be done using known in the art image blending techniques to ensure a natural and real image generation. The integrated image may be customized and resized to fit on the lock screen of the computing device. The step of customization includes optimizing the image to the standards of each computing device to ensure compatibility.

Further, in an implementation, the processing unit [102] is configured to apply one or more face-swap algorithms to further refine the images for displaying on the user device of the user. This may be achieved by integrating the user's facial features into the avatars. The face swapping technique ensures a high resemblance to the user, thereby personalizing each avatar without detracting from the chosen styling or aesthetic category. In an exemplary implementation, an upscaling technique is applied to improve the quality of the swapped facial area, ensuring clarity and detail. The processing unit [102], in an implementation, is configured to produce final images or the avatars after applying face swap algorithms and other image correction algorithms and store the final avatars in the storage unit [104].

For instance, the system [100] identifies the time to be 11:24 A.M. Since the sun is at its peak this time, the background may be generated with a bright sun at the top of the background with the one or more images uploaded by the user. An implementation of the example is shown in FIG. 3C at step [508B]. Using the same method, a background may be generated for all times of the day by the system [100].

At step [502B], the time is 7:30 P.M. Based on the time of sunset at the location, the image of the user is in a dull background which shows that the sun has set some time ago and the sky is still in darker shades of blue. At step [504B], the time is 7:30 A.M. The image shows that the sun is rising in a clear sky. Step [506B] and [508B] show varied weather conditions at the same time on different days. Step [506B] the display screen shows that the sun is visible which portrays that there might be clouds which makes it less sunny at this time of the day. Therefore, the background is a little dull in comparison to step [508B]. Whereas at step [508B], on a clear sky day, the sun is shining bright in the middle of the screen, and the background and the image of the user is brighter than the image at step [506B]. The system [100] is thus configured to display dynamic wallpapers in real-time to reflect the current time of day. In another implementation of the present disclosure, the dynamic wallpapers may be generated based one real-time weather updates.

Referring to FIG. 5C, it illustrates a series of avatars [500C] created using a user provided image and a style reference image. After selecting the theme for personal styling using reference image, the user uploads one or more images, for instance, a selfie [502C] on the computing device. The user profile may be created based on the one or more images of the user. The user profile may be created by identifying the facial features of the user. The user profile refers to a file of basic understanding of facial features of the user.

Based on the user profile, the features of the user may be superimposed on a style reference image [504C]. The superimposition may be done using known in the art techniques including but not limited to the deliberate model, the dreambooth model and the dreamshaper model. Each of the model may be used in a predefined weight ratio. The predefined weight ratio helps to multiple styles of the one or more avatars.

Once the superimposed image is generated, the image may be personalised using known in the art stable diffusion 1.5. Furthermore, a face swap operation may be used to enhance the one or more avatars. The face swap operation may integrate the user's facial features into the one or more avatars. The face swapping technique ensures a high resemblance to the user, thereby personalizing each of the one or more avatars without detracting from the chosen theme. In an embodiment, the resultant images may look like those at step [506C], [508C] and [510C].

As is evident from the above, the present disclosure describes a technically advanced solution for generating one or more avatars from at least one user image, which provides a significant technical advancement in the field of generating one or more avatars by leveraging artificial intelligence models in a weighted ratio. At least some embodiments of this innovation enable the seamless extraction and integration of real images into avatars having high resemblance. Notably, it breaks away from conventional norms by allowing dynamic display on the lock screen based on different themes including but not limited to location, time, weather. The wallpaper may change automatically based on the selected preference of the user. This ensures high engagement and higher personalisation of user's computing device. The processing unit skillfully presents the images in a realistic avatar form, transforming information from the server and the storage into an accessible format. This transformation takes place without relying on manual user interaction at every point, the user only needs to upload some pictures. In scenarios, where the user does not upload pictures, the processing unit is configured to extract images from the web based on recommendation of intelligence models. The intelligence models track user preferences and history to personalise user experience, enhancing the accessibility of vital information. Practical implementation of this solution introduces further dynamism: real-time dynamic update to the lock screen, influenced by variables such as predefined time intervals. usher in a significant advancement, revolutionizing the way information is presented and engaging users in novel ways.

While the present invention has been described with reference to certain preferred embodiments and examples thereof, other embodiments, equivalents and modifications are possible and are also encompassed by the scope of the present disclosure.

We claim:

1. A method for automatically generating one or more avatars from at least one user image, the method comprising:
receiving, by a processing unit, one or more images;
generating, by the processing unit, at least one user profile based on the one or more images;
merging, by the processing unit, the at least one user profile with one or more template profiles of one or more collections;
generating, by the processing unit, one or more avatars for the one or more collections; and
displaying, by the processing unit, the one or more avatars from the one or more collections on a computing device.

2. The method as claimed in claim 1, the method further comprising personalizing, by the processing unit, the one or more avatars from the one or more collections based on face swapping using the at least one user profile.

3. The method as claimed in claim 1, the method further comprising identifying, by the processing unit, at least one user face and one or more facial features associated with the at least one user face in the one or more images, wherein the at least one user profile comprises the one or more facial features associated with the at least one user face.

4. The method as claimed in claim 1, wherein the one or more avatars are generated based on a location, a time, a weather, a user preference, and a user behavior.

5. The method as claimed in claim 1, wherein the one or more collections are based on one or more themes, and wherein the one or more avatars in a one or more collections is generated based on one or more parameters associated with the one or more themes.

6. A system for automatically generating one or more avatars from at least one user image, the system comprising a processing unit connected to a storage unit, said processing unit configured to:
receive one or more images;
generate at least one user profile based on the one or more images;
merge the at least one user profile with one or more template profiles of one or more collections;
generate one or more avatars for the one or more collections; and
display the one or more avatars from the one or more collections on a computing device.

7. The system as claimed in claim 6, wherein the processing unit is further configured to personalize the one or more avatars from the one or more collections based on face swap using the at least one user profile.

8. The system as claimed in claim 6, wherein the processing unit is further configured to identify at least one user face and one or more facial features associated with the at least one user face in the one or more images, wherein the at least one user profile comprises the one or more facial features associated with the at least one user face.

9. The system as claimed in claim 6, wherein the one or more avatars are generated based on a location, a time, a weather, a user preference, and a user behavior.

10. The system as claimed in claim 6, wherein the one or more collections are based on one or more themes and wherein the one or more avatars in a one or more collections is generated based on one or more parameters associated with the one or more themes.
